(19) United States
(12) Patent Application Publication
(10) Pub. No.: US 2018/0003519 A1
(43) Pub. Date: Jan. 4, 2018

(54) NAVIGATION DEVICE AND METHOD OF CONTROLLING THE SAME

(71) Applicant: LG ELECTRONICS INC., Seoul (KR)

(72) Inventors: Sihwa PARK, Seoul (KR); Juhwan LEE, Seoul (KR); Sinae CHUN, Seoul (KR); Doyoung LEE, Seoul (KR)

(73) Assignee: LG ELECTRONICS INC., Seoul (KR)

(21) Appl. No.: 15/129,107

(22) PCT Filed: Oct. 22, 2014
(86) PCT No.: PCT/KR2014/009912

§ 371 Date: Sep. 26, 2016

(51) Int. Cl. G01C 21/36; G01C 21/34

(52) U.S. Cl. CPC G01C 21/3602; G01C 21/3617; G01C 21/3415

(57) ABSTRACT

A navigation device for a vehicle including a display unit, and a processor configured to determine a location of the navigation device, detect an object loaded into the vehicle by wirelessly communicating with the object, identify the detected object based on attribute information of the detected object, save a destination history of the identified object including destination information of the vehicle having the loaded identified object, and display at least one recommended destination on the display unit based on the destination history of the object in response to the identified object again being loaded into the vehicle after the destination history has been saved.

### CROSS REFERENCE TO THE RELATED APPLICATIONS

This application is the National Phase of PCT International Application No. PCT/KR2014/009912, filed on Oct. 22, 2014, which is hereby expressly incorporated by reference into the present application.

### BACKGROUND OF THE INVENTION

### Field of the Invention

The present invention relates to a navigation device and method of controlling the same.

### Description of the Related Art

Traditionally, a vehicle (e.g., a car) included mechanical devices. As the electronic technologies have been developed, electronic devices are installed in a vehicle. For instance, a vehicle tracks a location of a smart key and can perform a function corresponding to the location of the smart key.

A navigation device is one example of an electronic device of a vehicle. Various navigation devices are currently used owing to the popularization of navigation. For instance, such a device as a mobile navigation device, a navigation device built in a vehicle, a navigation application installed cellular phone or the like can perform a navigation function. Generally, such a navigation device can indicate a heading direction by tracking a real-time location of a vehicle while moving together with the corresponding vehicle.

Generally, a navigation device performs a destination search for setting a destination. Yet, a user should input a destination to a navigation device for the destination search. In order to solve such a problem, the navigation device may provide recommended destinations such as a list of recent destinations. However, the list of the recent destinations does not consider a current status of the user. Hence, the demand for an improved method of providing a recommended destination in consideration of user's context is rising.

### SUMMARY OF THE INVENTION

Accordingly, one technical task of the present specification is to provide a navigation device and method of controlling the same, by which a recommended destination is provided based on an external object. Particularly, the present specification provides a further improved navigation device configured to provide a recommended destination by creating a destination history associated with an external object.

To achieve these and other advantages and in accordance with the purpose of the present invention, as embodied and broadly described, a navigation device according to one embodiment of the present invention includes a display unit configured to display at least one image, the display unit configured to receive a touch input, a location determining unit configured to determine a location of the navigation device, a detecting unit configured to detect at least one object loaded into a vehicle, and a processor controlling the display unit, the location determining unit and the detecting unit, wherein the at least one object includes attribute information, wherein the navigation device is loaded into the vehicle, wherein the processor detects an object loaded into the vehicle, wherein the processor identifies the detected object based on the attribute information of the detected object, wherein the processor creates a destination history of the identified object including destination information of the vehicle having the identified object loaded thereinto, and wherein after the destination history has been created, if the identified object is loaded into the vehicle again, the processor provides at least one recommended destination based on the destination history of the object.

To further achieve these and other advantages and in accordance with the purpose of the present invention, as embodied and broadly described, a method of controlling a navigation device according to one embodiment of the present invention may include the steps of detecting an object loaded into a vehicle using a detecting unit, identifying the detected object based on attribute information included in the detected object, creating a destination history of the identified object including a destination information of the vehicle having the identified object loaded thereinto, and if the identified object is loaded into the vehicle again after creating the destination history, providing at least one recommended destination based on the destination history of the object.

A navigation device according to the present specification can provide a recommended destination to a user.

In addition, a navigation device according to the present specification can provide a recommended destination matching user's context by creating a recommended destination based on an identified object.

Moreover, a navigation device according to the present specification can statistically analyze user's context information by creating a destination history of an object.

### BRIEF DESCRIPTION OF THE DRAWINGS

FIG. 1 shows a network environment of a vehicle.

FIG. 2 is a diagram illustrating a configuration of a navigation device according to one embodiment.

FIG. 3 shows a destination setting of a navigation device according to one embodiment.

FIG. 4 shows a destination history according to one embodiment.

FIG. 5 shows an additional destination recommendation according to one embodiment.

FIG. 6 shows an input interface according to one embodiment.

FIG. 7 shows one example of a recommended destination for an identified object.

FIG. 8 shows one example of an object notification using a user device according to one embodiment.

FIG. 9 is a flowchart for a method of controlling a navigation device according to one embodiment.

### DETAILED DESCRIPTION OF THE EMBODIMENTS

Reference will now be made in detail to the preferred embodiments of the present invention, examples of which are illustrated in the accompanying drawings. In addition, the present invention may be non-limited by the preferred embodiments of the present invention.

First of all, although terminologies used in the present specification are selected from general terminologies used currently and widely in consideration of functions in the present invention, they may be changed in accordance with intentions of technicians engaged in the corresponding fields, customs, advents of new technologies and the like. Occasionally, some terminologies may be arbitrarily selected by the applicant(s). In this instance, the meanings of the arbitrarily selected terminologies shall be described in the corresponding part of the detailed description of the invention. Therefore, terminologies used in the present specification need to be construed based on the substantial meanings of the corresponding terminologies and the overall matters disclosed in the present specification rather than construed as simple names of the terminologies.

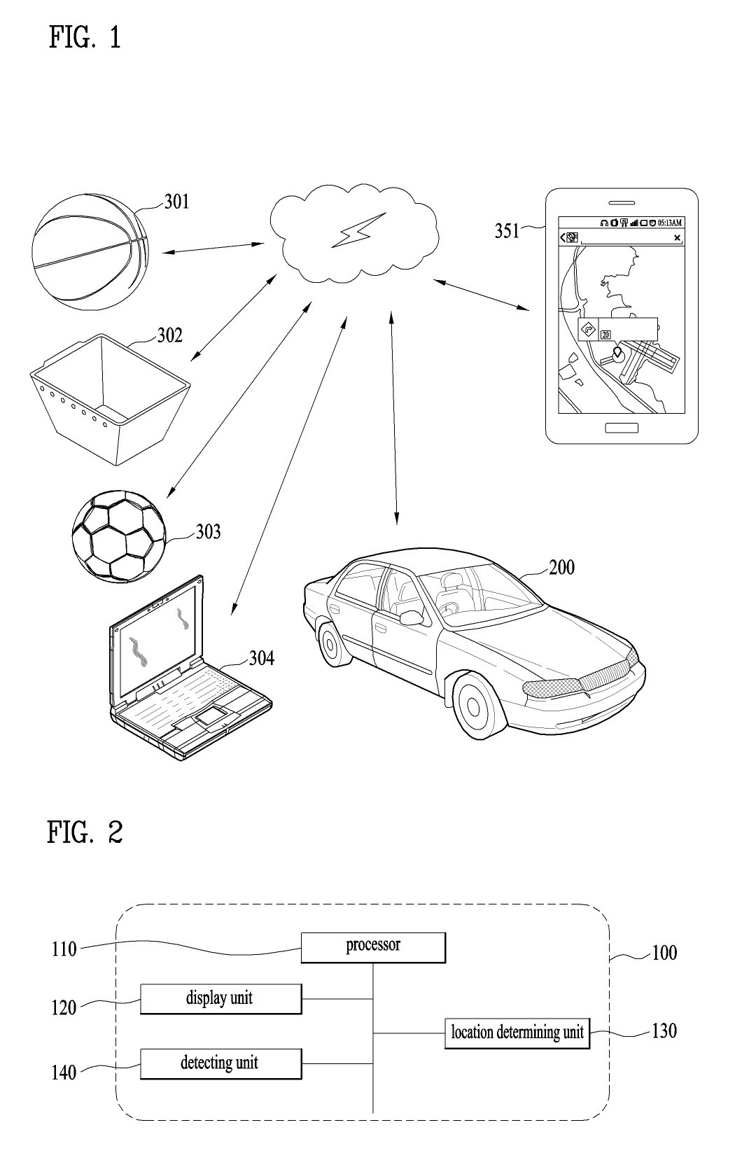

FIG. 1 shows a network environment of a vehicle. Referring to FIG. 1, a car is illustrated as one example of a vehicle 200. As electronic devices of a car increase, the car can communicate with various devices. For instance, the car 200 can communicate with a user device 351 through a network. In addition, the car 200 can communicate with the user device 351 through a system installed in the car 200 or a navigation device communicating with the system installed in the car 200. Moreover, the car 200 can communicate with various objects 301, 302, 303 and 304 loaded into the car 200. Communications with the objects 301, 302, 303 and 304 may be performed directly or indirectly.

Meanwhile, although FIG. 1 shows that the car is one example of the vehicle 200, the vehicle 200 may include other transportation means. For instance, the vehicle 200 may include one of a motorcycle, a bicycle, a ship, and an airplane. Moreover, the vehicle 200 in the present specification may include an automatic driving device. Moreover, although a basketball 301, a shopping basket 302, a football 303, and a laptop computer 304 are illustrated as examples of objects in FIG. 1, various objects can be used as the objects of the present specification. Moreover, although a mobile phone is illustrated as the user device 351, one of various portable devices is usable as the user device 351 of the present specification. For instance, the user device 351 may include one of a mobile phone, an electronic pocketbook, an HMD (head mounted display), and various portable devices.

Meanwhile, the objects 301, 302, 303 and 304 of the present specification can communicate with the vehicle 200 or the navigation device directly or indirectly. The communication of each of the objects 301, 302, 303 and 304 may be performed by a simple tag. For instance each of the objects 301, 302, 303 and 304 may not have a function for a separate data transmission/reception. In this instance, the vehicle 200 or the navigation device may identify the tag of each of the objects 301, 302, 303 and 304. Such tag identification may be included in a communication in a broad sense.

The navigation device of the present specification is not directly illustrated in FIG. 1. A navigation device mentioned in the following description may be built in the vehicle 200. For instance, the vehicle 200 may include a navigation device as a part of a vehicle system. Yet, a navigation device of the present specification may include a portable device instead of being built in a car. For instance, a mobile phone may operate as a navigation device of the present specification. Moreover, a navigation device of the present specification may be supplied with power from the vehicle 200 or may include a device from the vehicle 200.

FIG. 2 is a diagram illustrating a configuration of a navigation device according to one embodiment. As mentioned in the foregoing description with reference to FIG. 1, a navigation device may be a part of a vehicle system or a device detachable from a vehicle. The navigation device may include a location determining unit 130, a display unit 120, a detecting unit 140 and a processor 110.

The location determining unit 130 can determine a location of a navigation device 100. The location determining unit 130 may include a satellite location positioning system (GPS), a geographical information system (GIS), a terrestrial network based location positioning system and/or a hybrid supportive GPS wireless location determining system.

The detecting unit 140 can detect at least one object loaded into the vehicle. In addition, the detecting unit 140 can detect a loading of an object. For instance, the detecting unit 140 can detect a loading of an object by communicating with the object. The detecting unit 140 can detect a loading of an object based on a strength of a signal from the object, a strength of a signal reflected by the object, and/or a responding time from the object.

Moreover, the detecting unit 140 may detect a loading of an object using an object sensor provided to the vehicle. For instance, the vehicle includes an object sensor configured to sense a loading of an object, and the detecting unit 140 can communicate with the object sensor. In addition, the detecting unit 140 may determine a loading/unloading of an object based on a signal received from the object sensor of the vehicle.

Moreover, the detecting unit 140 can detect an object loaded into the vehicle. Moreover, the detecting unit 140 can identify an object based on an attribute information of the object. For instance, the attribute information of the object may include a name, ID, type and/or unique identification text of the object. By communicating with the object, the detecting unit 140 receives the attribute information of the object and may be then able to identify the object based on the attribute information. Moreover, the detecting unit 140 can identify an object by reading a tag included in the object.

Meanwhile, the detecting unit 140 may include a communication unit configured to communicate with an object, a user device and/or a vehicle, which are not shown in FIG. 2. Moreover, the detecting unit 140 may be coupled with a separate communication unit built in the navigation device 100. The communication unit performs communication through a wired or wireless network and can transmit/receive data. For instance, for an access to a wireless network, the communication unit can use WLAN (wireless LAN), IEEE 802.11 based wireless LAN communication, Wibro (wireless broadband), Wimax (world interoperability for microwave access), HSDPA (high speed downlink packet access), Bluetooth, NFC (near field communication) specifications, and the like. In addition, the communication unit can access Internet through the wire/wireless network.

The display unit 120 displays at least one image and can receive a touch input. The display unit 120 may include an LCD (liquid crystal display), a plasma display, or a display of a different type. In addition, the display unit 120 may include a touch sensor. In particular, the display unit 120 can include a touch-sensitive display unit. The touch sensor may be located on or within the display unit 120. The touch sensor can sense various contact inputs of contact or non-contact types such as a sliding touch input, a multi-touch input, a long-press touch input, a short-press touch input, a drag touch input, a hovering touch input, a flicking touch input and the like. In addition, the touch sensor can sense touch inputs applied by various input tools such as a touch pen, a stylus pen and the like. Moreover, the touch sensor can deliver a result of sensing a touch input to the processor 110.

The processor 110 can control the display unit 120, the location determining unit 130, and the detecting unit 140. In addition, the processor 110 may control other components included in the navigation device 100 mentioned in the following description. The processor 110 can launch various applications by processing data of the navigation device 100. Based on commands, the processor 110 can control the navigation device 100 and contents run in the navigation device 100.

Moreover, the navigation device 100 may further include components not shown in FIG. 2. For example, the navigation device 100 may further include a memory, a power source, a housing, an audio receiving unit, an audio output unit, or an image sensing unit. The image sensing unit can sense images using visible rays, infrared rays, ultraviolet rays, magnetic field and/or sound waves.

Moreover, the above-described components can be selectively combined in accordance with a selection made by a manufacturer or a type of the navigation device 100. The above-described components can be connected to each other via bus and can be controlled by the processor 110.

Meanwhile, the configuration diagram of the navigation device 100 shown in FIG. 1 is the block diagram according to one embodiment, in which the separately displayed block diagrams show the hardware configuration units logically distinguished from each other. Therefore, the configuration units of the navigation device 100 mentioned in the above description can be embodied into a single chip or a plurality of chips according to a device design.

Meanwhile, the navigation device 100 of the present specification can be controlled based on various inputs. For instance, the navigation device 100 may include a physical button and can receive an input from the physical button. In addition, the navigation device 100 may include a voice receiving unit, perform a voice recognition based on a received voice, and be controlled based on the voice recognition. In particular, the navigation device 100 may perform a voice recognition by syllable, word or sentence units or be able to perform a corresponding function by combining recognized syllables, words or sentences together.

In addition, the navigation device 100 can perform an image analysis using an image sensing unit and may be controlled based on an analyzed image. Moreover, the navigation device 100 may include a touch sensing unit and be controlled based on a touch input to the touch sensing unit. Besides, the navigation device 100 may be controlled based on the combination of the above-mentioned inputs.

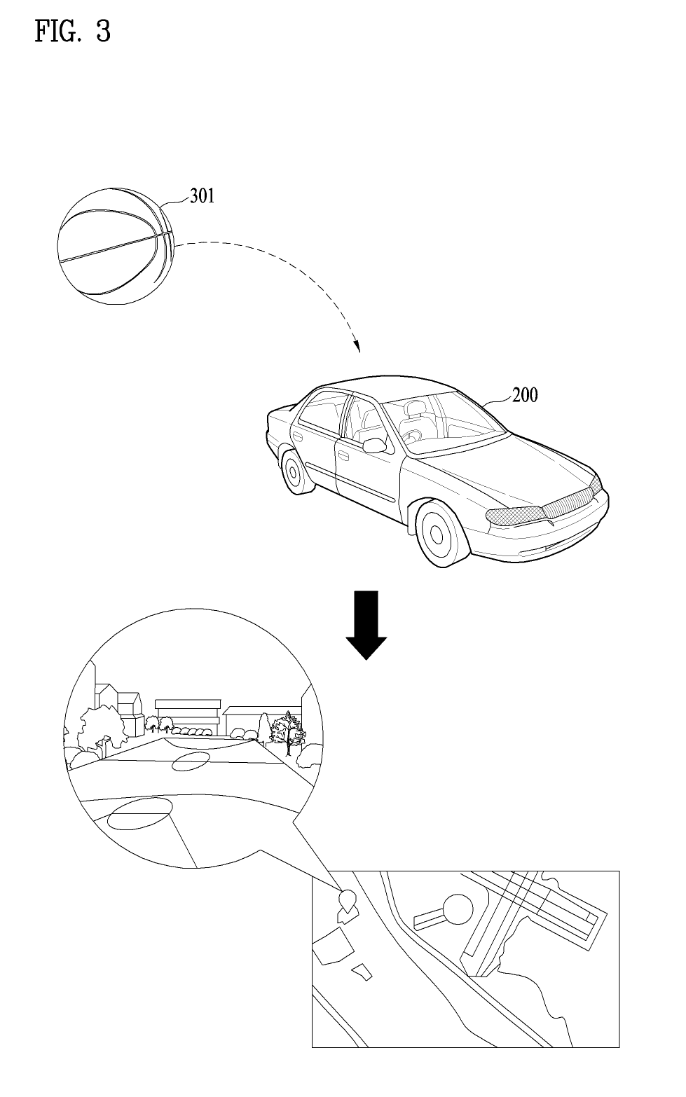

In the following description, operations performed in the navigation device 100 are described with reference to FIGS. 3 to 9. The configuration of the navigation device 100 described in detail with reference to FIG. 1 and FIG. 2 may be usable for the following operations of the navigation device 100. Moreover, an operation of the navigation device 100 and an operation of the processor 110 may be described by being equated with each other. Moreover, the navigation device 100 in the following may be built in or loaded into a vehicle.

FIG. 3 shows a destination setting of a navigation device according to one embodiment. Referring to FIG. 3, a navigation device is currently built in or loaded into a vehicle 200. In FIG. 3, a basketball 301 is loaded into the vehicle 200. As mentioned in the foregoing description with reference to FIG. 2, the navigation device can identify an object (e.g., basketball 301) using the detecting unit.

For example, the basketball 301 may include a tag that is wirelessly identifiable. By detecting the tag, the navigation device can detect the basketball 301 loaded into the vehicle 200. Moreover, attribute information on the basketball 301 may be included in the tag of the basketball 301. As mentioned in the foregoing description with reference to FIG. 1 and FIG. 2, the basketball 301 can communicate with the navigation device. In this instance, the navigation device may receive the attribute information based on the communication with the basketball 301. Hence, the navigation device can identify the basketball 301 loaded into the vehicle 200 based on the attribute information.

Moreover, the navigation device can create a destination history of the object (e.g., basketball 301) including destination information of the vehicle 200 having moved by having the basketball 301 loaded thereinto. Generally, a user seated in the vehicle 200 sets a destination. In this instance, the navigation device may control the set destination to be included in the destination history of the basketball 301. Yet, the user may move to a destination without setting the destination in the navigation device. In this instance, the navigation device may control a location, at which the vehicle 200 stopped and at which the basketball 301 was loaded, to be included in the destination history of the basketball 301. In the case shown in FIG. 3, a prescribed basketball court on a map is set as the destination. Further, the navigation device controls the corresponding basketball court to be included in the destination history of the basketball 301.

Meanwhile, after the destination history of the object (e.g., basketball 301) has been created, if the object is loaded into the vehicle again, the navigation device can provide at least one recommended destination based on the created destination history. That is, if the basketball 301 is loaded into the vehicle 200, the navigation device can provide a recommended destination based on the destination history previously created for the basketball 301.

For example, the navigation device can provide a destination of a highest rank in the destination history of the basketball 301 as the recommended destination. For instance, the navigation device may provide the basketball court in the destination history of the basketball 301 as the recommended destination for the basketball 301. Sorting/classification of destinations in the destination history shall be described with reference to FIG. 4 later.

The navigation device may provide a single destination as a recommended destination. Yet, the navigation device may provide at least two destinations (e.g., destinations in the destination history) as recommended destinations. The navigation device may provide a recommended destination through the display unit or the audio output unit. Moreover, the navigation device may automatically set a destination to a destination of a highest rank. When the vehicle 200 includes an automatic driving device, the vehicle 200 may be driven to a destination based on a set destination.

FIG. 4 shows a destination history according to one embodiment. Referring to FIG. 4, a destination 301 for a basketball 301 is illustrated. As mentioned in the foregoing description with reference to FIG. 3, the navigation device may create a destination history of an identified object (e.g., basketball 301). The destination history may include a location, a last visit date, and a visit count of a destination.

For example, the location of the destination may include geographical coordinates. In addition, the destination may be identified as a name of the destination. Moreover, a name and ID are shown as the attribute information on the basketball 301 in FIG. 4. Yet, as mentioned in the foregoing description with reference to FIG. 2, the attribute information may include a name, ID, type and/or unique identification text of an object.

In the destination history shown in FIG. 4, a destination, a last visit date and a visit count are included. This is just exemplary. In addition, the destination history may include other information. For example, the navigation device distinguishes a location for loading the object (e.g., basketball 301) into the vehicle from a location for unloading the object from the vehicle and can then have the distinguished locations included in the destination history. Hence, the navigation device can identify a loaded location of a prescribed object and an unloaded location of the prescribed object based on the statistical experience.

Moreover, the navigation device can classify or sort the destination history and such classification of the destination history may be reflected in providing a recommended destination mentioned in the following description. For instance, a destination of a highest rank in the destination history may be provided as a recommended destination.

Moreover, the navigation device can provide a plurality of recommended destinations in order of sorting the destination history. For instance, the navigation device may classify the destination history based on a last visit date and/or a frequency of visit.

Moreover, the navigation device may classify destinations in the destination history based on a location of the navigation device. For instance, the navigation device can classify destinations in the destination history in order of distance closer to a current location of the navigation device.

The sorting/classification of the destination history of the navigation device described with reference to FIG. 4 may be selectively combined with the operation of the navigation device described with reference to FIG. 3.

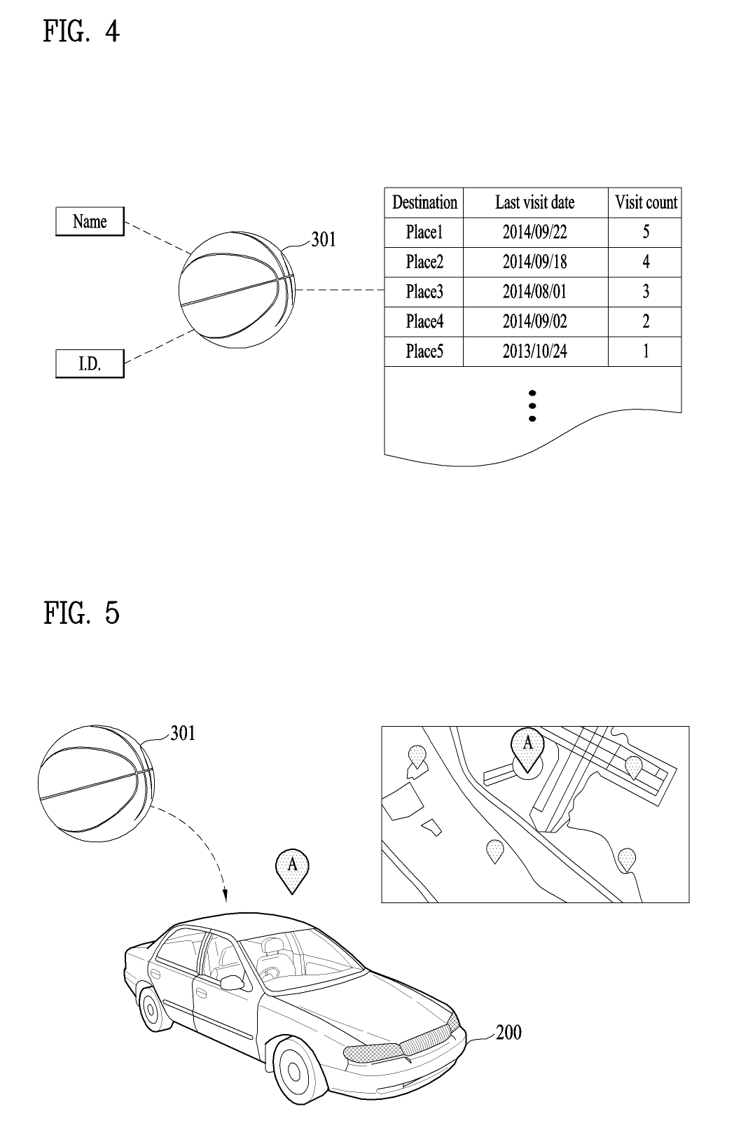

FIG. 5 shows an additional destination recommendation according to one embodiment. As mentioned in the foregoing description with reference to FIG. 3, the navigation device can provide at least one recommended destination. Moreover, if an object is loaded into a vehicle 200, the navigation device can provide at least one additional destination based on attribute information of the object and a location of the navigation device.

Referring to FIG. 5, a basketball 301 is loaded as an object into the vehicle 200. The basketball 301 can be identified by the navigation device. The navigation device can search for a destination matching the basketball 301 from the attribute information (e.g., a name called a basketball) of the basketball 301. For instance, the navigation device can search for a basketball court as a destination that matches the basketball 301.

In doing the search, a location of the navigation device may be taken into consideration. For instance, basketball courts located in a preset distance from the location of the navigation device can be provided as recommended destinations. In particular, the object of an additional recommended destination is to additionally provide a user with a destination failing to exist in a destination history of the identified object (e.g., basketball 301).

For instance, the navigation device may determine a type of an object based on attribute information of the object loaded into the vehicle 200. Moreover, the navigation device can provide a location, which exists in a preset distance from a location of the navigation device among locations corresponding to the determined type of the object, as at least one recommended destination.

That is, the navigation device can perform a similar/semantic search based on the attribute of the basketball 301 as well as a search for a destination matching a name of the basketball 301. Moreover, in providing an additional recommended destination, since a current location of the navigation device is taken into consideration, the navigation device can provide recommendation of a new place failing to be visited by a user.

The operation of providing the additional recommended destination described with reference to FIG. 5 may be selectively combined with the operations of the navigation device described with reference to FIG. 3 and FIG. 4.

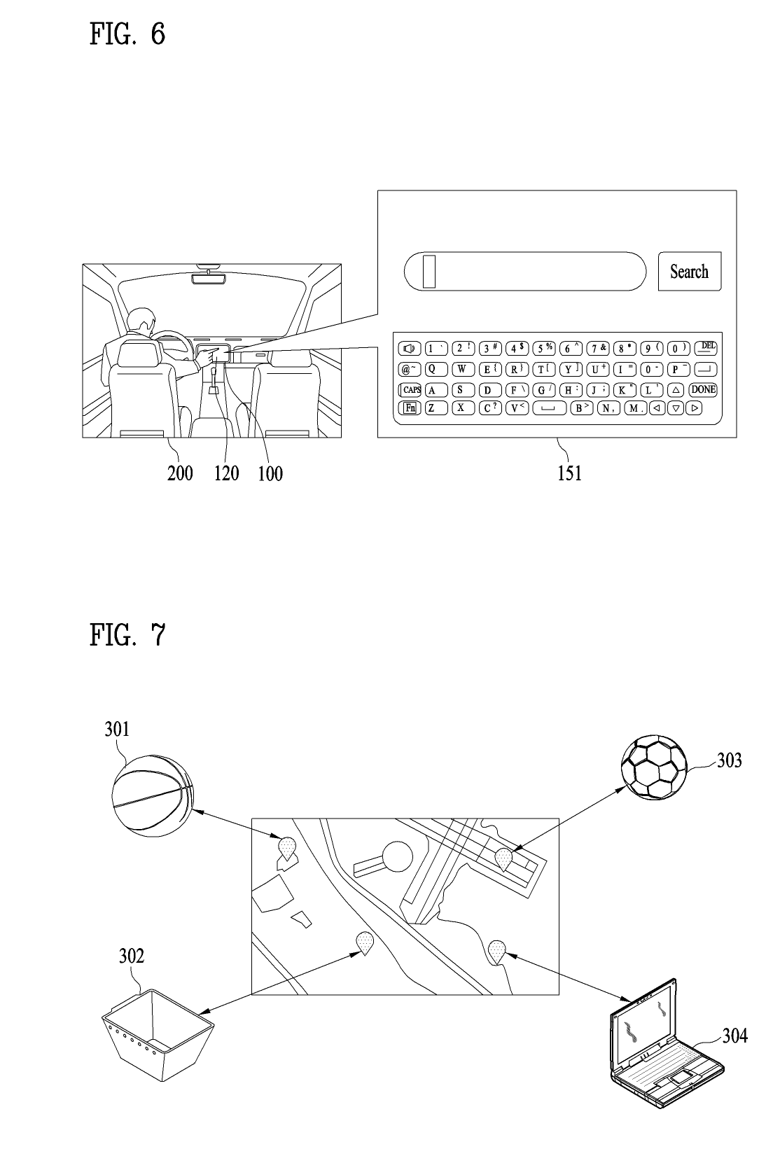

FIG. 6 shows an input interface according to one embodiment. Referring to FIG. 6, a navigation device 100 includes a display unit 120 and is installed in a vehicle 200. As mentioned in the foregoing description, the navigation device 100 can be installed by being detachable from the vehicle 200.

As shown in FIG. 6, the navigation device 100 may provide an interface 151, which is provided to set a destination of the vehicle 200, onto the display unit 120. A user can search for or set a destination through a virtual keyboard on the interface 151.

Based on an input to the interface 151, the navigation device 100 may set a destination. If the set destination exists in a destination history of an identified object and the identified object is not loaded into the vehicle, the navigation device can provide a notification of the absence of the identified object.

Referring to FIG. 3, the notification of the absence of the identified object is described as follows. Referring to FIG. 3, a specific basketball court is included in the destination history of the basketball 301. A user can set the corresponding basketball court as a destination using the interface 151 shown in FIG. 6. In this instance, if the basketball 301 is not loaded into the vehicle 200, the navigation device can inform a user that the basketball 301 is not loaded.

For instance, if the corresponding basketball court is set as the destination and the basketball 301 is not loaded into the vehicle 200, the navigation device can provide the user with a notification, which indicates that ‘Will you bring the basketball with you?’, through the display unit or the audio output unit. Hence, the user can bring the basketball to the basketball court without forgetting it.

The operation of providing the notification described with reference to FIG. 6 may be selectively combined with the operations of the navigation device described with reference to FIGS. 3 to 5.

FIG. 7 shows one example of a recommended destination for an identified object. As mentioned in the foregoing description with reference to FIGS. 1 to 6, the navigation device can create a destination history of an identified object. That is, an object and a destination can be associated with each other. Hence, as mentioned in the foregoing description with reference to FIG. 3, if an identified object is loaded into a vehicle, the navigation device can provide an associated destination as a recommended destination.

On the contrary, as mentioned in the foregoing description with reference to FIG. 6, if an associated object is not loaded into a vehicle despite that a destination included in a destination history is set as a destination, the navigation device can indicate the absence of the associated object. Moreover, the navigation device identifies at least one object and can create a destination history of each identified object. For instance, as shown in FIG. 7, objects 301, 302, 303 and 304 can be associated with different places, respectively.

Moreover, after arrival at a destination, the navigation device can provide a notification of an unload of an identified object. For instance, in FIG. 7, a user may move to a place associated with a soccer ball 303 while the soccer ball 303 is loaded into a vehicle. In this instance, if the vehicle arrives at the place associated with the football 303, the navigation device can notify the user to unload the soccer ball 303. Hence, such a notification can prevent the user from getting off the vehicle at a place associated with a specific object without carrying the specific object.

As mentioned in the foregoing description with reference to FIG. 4, the navigation device identifies an object, distinguishes a loaded/unloaded place of the identified object, and can save it to a destination history. Hence, the navigation device provides a recommended destination based on an object and can also recommend a load/unload of the object based on a destination.

Moreover, the operation of providing the notification described with reference to FIG. 7 may be selectively combined with the operations of the navigation device described with reference to FIGS. 3 to 6.

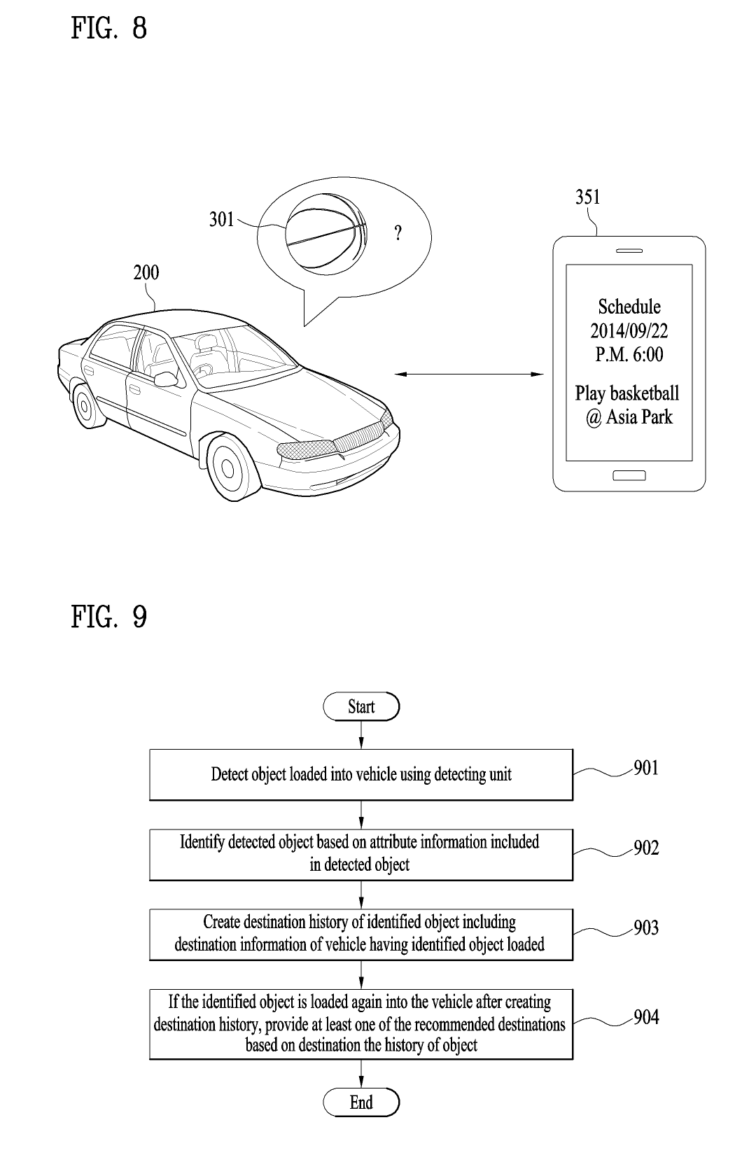

FIG. 8 shows one example of an object notification using a user device according to one embodiment. With respect to FIGS. 3 to 7, methods of providing a recommended destination or a notification based on an object or a location (destination) have been described. Yet, the navigation device can provide a recommended destination or a notification using a separate user device. For instance, the user device 351 may include a schedule application.

As mentioned in the foregoing description with reference to FIG. 2, the navigation device can communicate with the user device 351 loaded into the vehicle 200 using a communication unit. For instance, the navigation device can receive a schedule information from the user device 351.

For example, as shown in FIG. 8, the schedule information may include a time, a place and a brief description. Moreover, the navigation device can identify an object associated with a present or future schedule of the user device 351 based on the schedule information. For instance, the navigation device can identify a basketball 301 as an object associated with a schedule ‘play basketball’.

Moreover, if the object associated with the present or future schedule is not loaded into the vehicle 200, the navigation device can provide a notification of the absence of the object. For instance, assume that a user gets on the vehicle 200 at 4 P.M. on Sep. 22, 2014. In this instance, the navigation device can receive schedule information from the user device 351.

Moreover, based on the received schedule information, the navigation device can identify the basketball 301 as an associated object. Further, if the identified object, i.e., the basketball 301 is not loaded into the vehicle 200, the navigation device may propose a user to bring the basketball 301 together. Hence, the user can bring the object necessary for a future schedule without forgetting it.

Meanwhile, through the present specification, the user device 351 and the navigation device are described as separate devices, respectively. Yet, the user device 351 and the navigation device may be the same device. For instance, the navigation device may be a mobile phone including a navigation application.

In this instance, the mobile phone may include a schedule application. Hence, the mobile phone can provide a notification of the absence of the object described with reference to FIG. 8 based on a schedule information of the schedule application.

The operation of providing the notification described with reference to FIG. 8 may be selectively combined with the operations of the navigation device described with reference to FIGS. 3 to 7.

FIG. 9 is a flowchart for a method of controlling a navigation device according to one embodiment. A navigation device detects an object loaded into a vehicle using a detecting unit (901) and can identify the detected object based on attribute information included in the detected object (902).

As mentioned in the foregoing description with reference to FIG. 2 and FIG. 3, the navigation device can identify an object by communicating with an object, identifying a tag of the object, or using a sensor built in the vehicle. The navigation device creates a destination history 903 of the identified object including a destination information of the vehicle having the identified object loaded thereinto (903).

As mentioned in the foregoing description with reference to FIG. 3, the navigation device can create the destination history based on various methods. Moreover, as mentioned in the foregoing description with reference to FIG. 4, the navigation device can classify the destination history. Moreover, after the destination history has been created, if the identified object is loaded into the vehicle again, the navigation device can provide at least one recommended destination based on the destination history of the object (904).

As mentioned in the foregoing description with reference to FIG. 3, one recommended destination or a plurality of recommended destinations can be provided. Moreover, the navigation device can set the recommended destination as a destination of the vehicle. Moreover, the method of controlling the navigation device in FIG. 9 can be selectively combined with the operations of the navigation device described with reference to FIGS. 3 to 8. Moreover, the method of controlling the navigation device in the present specification can be performed by the navigation device described with reference to FIG. 1 and FIG. 2.

A navigation device and method of controlling the same according to the present specification may be non-limited by the configurations and methods of the embodiments mentioned in the foregoing description. In addition, the embodiments mentioned in the foregoing description can be configured by being selectively combined with one another entirely or in part to enable various modifications.

Meanwhile, a navigation device and method of controlling the same according to the present specification can be implemented with processor-readable codes in a processor-readable recording medium provided to a network device. The processor-readable medium may include all kinds of recording devices capable of storing data readable by a processor. The processor-readable medium may include one of ROM, RAM, CD-ROM, magnetic tapes, floppy discs, optical data storage devices, and the like for example and also include such a carrier-wave type implementation as a transmission via Internet. Furthermore, as the processor-readable recording medium is distributed to a computer system connected via network, processor-readable codes can be saved and executed according to a distributive system.

It will be appreciated by those skilled in the art that various modifications and variations can be made in the present invention without departing from the spirit or scope of the inventions. Thus, it is intended that the present invention covers the modifications and variations of this invention provided they come within the scope of the appended claims and their equivalents.

1. A navigation device for a vehicle, comprising:
a display unit; and
a processor configured to:
determine a location of the navigation device,
detect an object loaded into the vehicle by wirelessly communicating with the object,
identify the detected object based on attribute information of the detected object,
save a destination history of the identified object including destination information of the vehicle having the loaded identified object, and
display at least one recommended destination on the display unit based on the destination history of the object in response to the identified object again being loaded into the vehicle after the destination history has been saved.

2. The navigation device of claim 1, wherein the processor is further configured to classify the at least one recommended destination based on a visit frequency of destinations in the destination history of the identified object.

3. The navigation device of claim 2, wherein the processor is further configured to set the destination of the vehicle to the destination having a highest visit frequency among the destinations in the destination history of the identified object.

4. The navigation device of claim 1, wherein the processor is further configured to classify the at least one recommended destination based on last visit dates of destinations in the destination history of the identified object.

5. The navigation device of claim 1, wherein the processor is further configured to classify the at least one recommended destination based on a location of the navigation device.

6. The navigation device of claim 1, wherein the processor is further configured to display at least one additional recommended destination on the display unit based on the attribute information of the identified object and a location of the navigation device in response to the identified object again being loaded into the vehicle, after the destination history has been saved.

7. The navigation device of claim 6, wherein the processor is further configured to:
determine a type of the identified object based on the attribute information, and
display at least one location on the display unit corresponding to the type of the identified object existing in a preset distance from the location of the navigation device as the at least one additional recommended destination.

8. The navigation device of claim 1, wherein the processor is further configured to display an interface for setting a destination of the vehicle on the display unit.

9. The navigation device of claim 8, wherein the processor is further configured to:
set the destination based on an input to the interface, and
output a notification of an absence of the identified object if the set destination exists in the destination history of the identified object and the identified object is not loaded into the vehicle.

10. The navigation device of claim 1, wherein the processor is further configured to receive a signal including the attribute information of the object from the object.

11. The navigation device of claim 1, wherein the processor is further configured to determine whether the object is loaded into or unloaded from the vehicle based on at least one of a strength of a signal received from the object and a response time of the object.

12. The navigation device of claim 11, wherein the processor is further configured to save the destination history of the object based on a first location for loading the object into the vehicle and a second location for unloading the object from the vehicle.

13. The navigation device of claim 12, wherein the processor is further configured to output a notification after arriving at the second location if the object is loaded into the vehicle and the navigation device moves to the second location from the first location.

14. The navigation device of claim 1, wherein the processor is further configured to:
communicate with at least one object sensor provided to the vehicle, and
determine whether the object is loaded into or unloaded from the vehicle based on a signal received from the at least one object sensor.

15. The navigation device of claim 1, further comprising:
a communication unit configured to communicate with a user device,
wherein the processor is further configured to:
receive schedule information from the user device loaded into the vehicle, and
identify an object associated with a present or future schedule of the user device based on the schedule information.

16. The navigation device of claim 15, wherein the processor is further configured to output a notification of an absence of the object if the object associated with the present or future schedule is not loaded into the vehicle.

17. A method of controlling a navigation device in a vehicle, the method comprising:
detecting, via a processor of the navigation device, an object loaded into the vehicle by wirelessly communicating with the object;
identifying, via the processor, the detected object based on attribute information included in the detected object;
saving, via the processor, a destination history of the identified object including a destination information of the vehicle having the loaded identified object; and
displaying, via a display unit of the navigation device, at least one recommended destination based on the destination history of the object in response to the identified object being again loaded into the vehicle after saving the destination history.

18. The method of claim 17, wherein the at least one recommended destination is classified based on a visit frequency of destinations included in the destination history of the identified object.

19. The method of claim 17, wherein the at least one recommended destination is classified based on last visit dates of destinations in the destination history of the identified object.

20. The method of claim 17, further comprising:
determining, via the processor, a location of the navigation device; and
displaying, via the display unit, at least one additional recommended destination based on the attribute information of the identified object and the location of the navigation device in response to the identified object being again loaded into the vehicle again after the destination history has been saved.

21. The method of claim 17, further comprising:
receiving a destination of the vehicle from a user; and
outputting a notification of an absence of the identified object if the received destination is included in the destination history of the identified object and the identified object is not loaded into the vehicle.
